(19) United States
(12) Patent Application Publication
(10) Pub. No.: US 2009/0180052 A1
(43) Pub. Date: Jul. 16, 2009

(54) LIQUID CRYSTAL DISPLAY DEVICE AND BACK LIGHT UNIT THEREOF

(76) Inventors: Hsu-Sheng Hsu, Hsin-Chu (TW); Chih-Wei Chen, Hsin-Chu (TW); Yun-Hsien Chou, Hsin-Chu (TW); Yung-Hsin Liu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/100,419

(22) Filed: Apr. 10, 2008

(30) Foreign Application Priority Data
Jan. 16, 2008 (TW) 097101625

(51) Int. Cl. G02F 1/1335

(52) U.S. Cl. 349/62

(57) ABSTRACT

A back light unit adapted to provide light to a liquid crystal display panel includes a housing, at least a light generator, and an optical filter. The light generator is disposed inside the housing for generating white light beams. The optical filter is disposed in an optical path of the white light beams between the light generator and the liquid crystal display panel for filtering the white light beams within a particular wavelength range of visible light. The hue of the white light beams before and after passing through the optical filter are the same.

### BACKGROUND OF THE INVENTION

1. Field of the Invention

The present invention relates to a liquid crystal display panel and back light unit thereof, and more particularly, to a liquid crystal display panel and a back light unit having an optical filter, which can filter light beams within a particular wavelength range of visible light, capable of displaying images with high gamut.

2. Description of the Prior Art

LCD (liquid crystal display) device is not self-luminous display device, and thus necessitates back light unit to display images. For this reason, back light unit is one of the key components of LCD device, and the characteristic of back light dominates the display quality. Normally, the back light unit is installed in the back side of the LCD device, while the front side of the LCD device is used to display. The back light unit generally includes a housing, a light generator e.g. fluorescent lamp, a diffuser, and a light guide plate, etc. Based on the location of light generator, the back light unit can be classified into two types: 1) Direct-light type in which the light generator is positioned right below the LCD panel; and 2) Edge-light type in which the light generator is positioned corresponding to the edge of the LCD panel.

As the requirement of display quality increase, the requirement of color performance in LCD also raises. Accordingly, some conventional methods such as changing the material of phosphorous coating, adjusting the characteristic of color filter, or using three light emitting diode devices with different colors have been proposed to enlarge the gamut. However, the conventional methods involve the change of original design of the LCD device or back light unit or increase the amount of light emitting diode devices, thereby causing extra costs and complexity in driving. Consequently, to enlarge the gamut of LCD device without altering current LCD device and back light unit design is an important issue to develop.

### SUMMARY OF THE INVENTION

It is therefore one of the objectives of the claimed invention to provide an LCD device and a back light unit to improve the gamut of the LCD device.

According to the claimed invention, a back light unit adapted to provide light to a liquid crystal display panel is provided. The back light unit includes a housing, at least a light generator, and an optical filter. The at least one light generator is disposed inside the housing for generating white light beams. The optical filter is disposed in an optical path of the white light beams between the light generator and the liquid crystal display panel for filtering the white light beams within a particular wavelength range of visible light. The hue of the white light beams before and after passing through the optical filter are the same.

According to the claimed invention, a liquid crystal display device is also provided. The LCD device includes a liquid crystal display panel, and a back light unit disposed below the liquid crystal display panel for providing light to the liquid crystal display panel. The LCD panel includes a color filter. The back light unit includes a housing, at least a light generator, and an optical filter. The at least one light generator is disposed inside the housing for generating white light beams. The optical filter is disposed in an optical path of the white light beams between the light generator and the liquid crystal display panel. The optical filter has a particular transmittance with respect to light beams within a particular wavelength range of visible light.

The installation of the optical filter makes it easy to filter out the light beams within unnecessary wavelength range of visible light without altering current back light unit design, and therefore can improve the gamut of LCD device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an LCD device and a back light unit thereof according to an embodiment of the present invention.

FIG. 2 is a transmittance vs. wavelength relationship chart.

FIG. 3 illustrates color coordinates of the three-wave LED light source incorporated with an optical filter.

FIG. 4 is a transmittance vs. wavelength relationship chart.

FIG. 5 illustrates color coordinates of the two-wave LED light source incorporated with an optical filter.

FIG. 6 schematically illustrates an LCD device according to another embodiment of the present invention.

FIG. 7 is a schematic diagram illustrating an LCD device according to another embodiment of the present invention.

FIG. 8 is a schematic diagram illustrating an LCD device according to another embodiment of the present invention.

FIG. 9 is a schematic diagram illustrating an LCD device according to another embodiment of the present invention.

FIG. 10 is a schematic diagram illustrating an LCD device according to another embodiment of the present invention.

FIG. 11 illustrates color coordinates of the CCFL light source incorporated with an optical filter.

### DETAILED DESCRIPTION

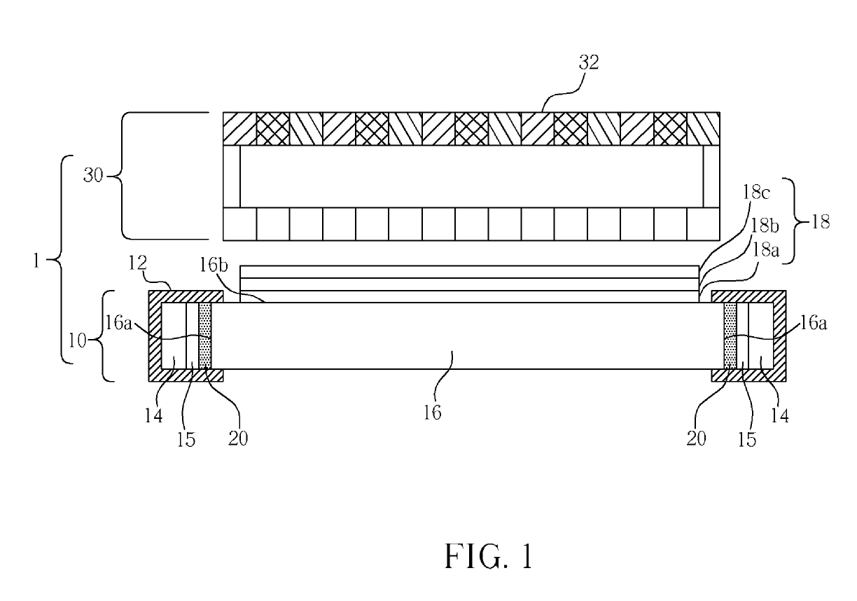

Please refer to FIG. 1. FIG. 1 is a schematic diagram illustrating an LCD device and a back light unit thereof according to an embodiment of the present invention. In this embodiment, the LCD device 1 includes an LCD panel 30, and a back light unit 10 disposed under the LCD panel 30. The back light unit 10 is an edge-light type back light unit, which provides light for the LCD panel 30 when displaying images. The back light unit 10 includes a housing 12, light generators 14, a light guide plate 16, and a diffusion device 18. The light generators 14 are disposed on two opposite sides of the housing 12 for generating white light beams. Note that the light generators 14 may also be located on one side of the housing 12 based on different brightness requirement. The light guide plate 16 is disposed inside the housing 12, and the light beams generated by the light generators 14 enter the light guide plate 16 from two sides, and are reflected to the LCD panel 30. The diffusion device 18 is disposed in between the back light unit 10 and the LCD panel 30. In addition, the LCD panel 30 includes color filters 32, which divide the white light beams into red, green, and blue light beams.

In this embodiment, the light generators 14 are white light emitting diode (LED) device having an encapsulated layer 15. The light guide plate 16 has an incident plane 16a and an exiting plane 16b, wherein the incident plane 16a is the plane where the light beams enter, and the exiting plane 16b is the plane where the light beams exit. The light guide plate 16 is used to transfer the incident light in a lateral direction into the exiting light in a direction toward the LCD panel 30. The diffusion device 18 may include diffusion plate 18a, prism 18b, brightness enhanced film 18c, or other optical thin films, which can equalize the light distribution and increase light utilization.

In this embodiment, the back light unit 10 includes optical filters 20 disposed in the optical path of the white light beams between the light generators 14 and the LCD panel 30. As shown in FIG. 1, the optical filters 20 are disposed in between the light generators 14 and the light guide plate 16; specifically, the optical filters 20 are located in front of the incident plane 16a of the light guide plate 16. The function of the optical filter 20 is to filter the white light beams before entering the light guide plate 16 without altering the hue of the white light beams. The optical filter 20 can filter out the light beams within a particular wavelength range of visible light, particularly the light beams having a wavelength between red light wavelength range and green light wavelength range, or between green light wavelength range and blue light wavelength range, so that the wavelength ranges of red light, green light, and blue light are more distinct from one another. Accordingly, the gamut of display images of the LCD panel 30 is increased.

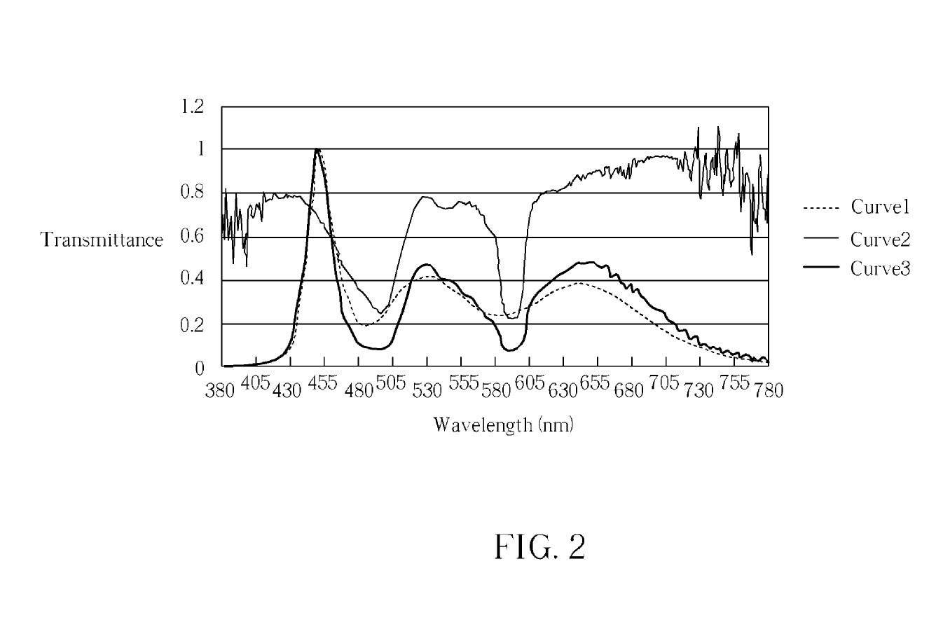

Please refer to FIG. 2. FIG. 2 is a transmittance vs. wavelength relationship chart. In this embodiment, a three-wave white LED device is used as light source. Curve 1 represents a transmittance vs. wavelength relation with respect to the white light beams of the light source, curve 2 represents a transmittance vs. wavelength relation with respect to the optical filter 20, and curve 3 represents a transmittance vs. wavelength relation with respect to the white light beams after going through the optical filter 20. As curve 1 of FIG. 2 shows, the white light source of the back light unit 10 substantially has three peaks within the visible light wavelength range (approximately between 380 nm and 780 nm). These three peaks respectively correspond to the blue light, the green light, and the red light wavelength ranges. However, the transmittance of the visible light in the two troughs within the three peaks is approximately 20%, which makes it difficult to differentiate from the boundary between red light and green light, or between green light and blue light. Therefore, using the above white light source degrades the gamut of the LCD panel 30.

As curve 2 of FIG. 2 shows, the optical filter 20 has lower transmittance with regard to the light beams within a particular wavelength range, particularly to the light beams having a wavelength between the red light wavelength range and the green light wavelength range, and the light beams having a wavelength between the green light wavelength range and the blue light wavelength range. For example, the transmittance of the optical filter 20 with regard to the red-green light having a wavelength between 565 nm and 615 nm, and with regard to the green-blue light having a wavelength between 473 nm and 523 nm is approximately 20%. In contrast, the transmittance of the light having a wavelength beyond the aforementioned ranges reaches 50% to 100%. It is appreciated that the relation between the transmittance and wavelength of the optical filter 20 can be controlled to fit different types of light sources by, for instance, using different materials or adding proper dyes. Basically, a better effect can be seen when the transmittance of visible light within a particular wavelength range is regulated down to between 10% and 40%, but the transmittance is not limited to the above range.

Due to the aforementioned characteristic of the optical filter 20, most of the light beams of the white light source shown by curve 1 having the wavelength between the red light wavelength range and the green light wavelength, and between the green light wavelength range and the blue light wavelength range are filtered before entering the light guide plate 16. As a result, the white light beams coming out from the back light unit 10 will contain distinctive red light, green light, and blue light. As shown by curve 3, the intensity of the light beams located between the red light wavelength range and the green light wavelength range, and the intensity of the light beams located between the green light wavelength range and the blue light wavelength range are significantly reduced, while the intensity of the light beams within the red light wavelength range, within the green light wavelength range, and within the blue light wavelength range is nearly unchanged.

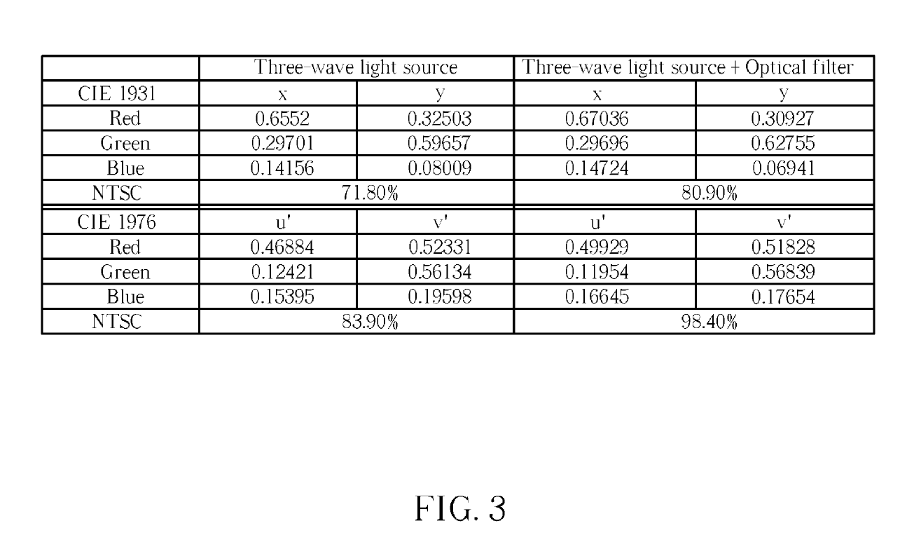

Please refer to FIG. 3. FIG. 3 illustrates color coordinates of the three-wave LED light source incorporated with an optical filter, wherein two color matching functions including CIE 1931 and CIE 1976 are shown in FIG. 3. According to CIE 1931 system, the light source without an optical filter 20 incorporated therein has a red light coordinate (x, y) of (0.6552, 0.32503), a green light coordinate of (0.29701, 0.59657), a blue light coordinate of (0.14156, 0.08009), and an NTSC percentage of 71.80%; the light source with an optical filter 20 has a red light coordinate of (0.67036, 0.30927), a green light coordinate of (0.29696, 0.62755), a blue light coordinate of (0.14724, 0.06941), and an NTSC percentage of 80.90%. According to CIE 1976 system, the light source without an optical filter 20 incorporated therein has a red light coordinate (u′, v′) of (0.46884, 0.52331), a green light coordinate of (0.12421, 0.56134), a blue light coordinate of (0.15395, 0.19598), and an NTSC percentage of 83.90%; the light source with an optical filter 20 has a red light coordinate of (0.49929, 0.51828), a green light coordinate of (0.11954, 0.56839), a blue light coordinate of (0.16645, 0.17654), and an NTSC percentage of 98.40%.

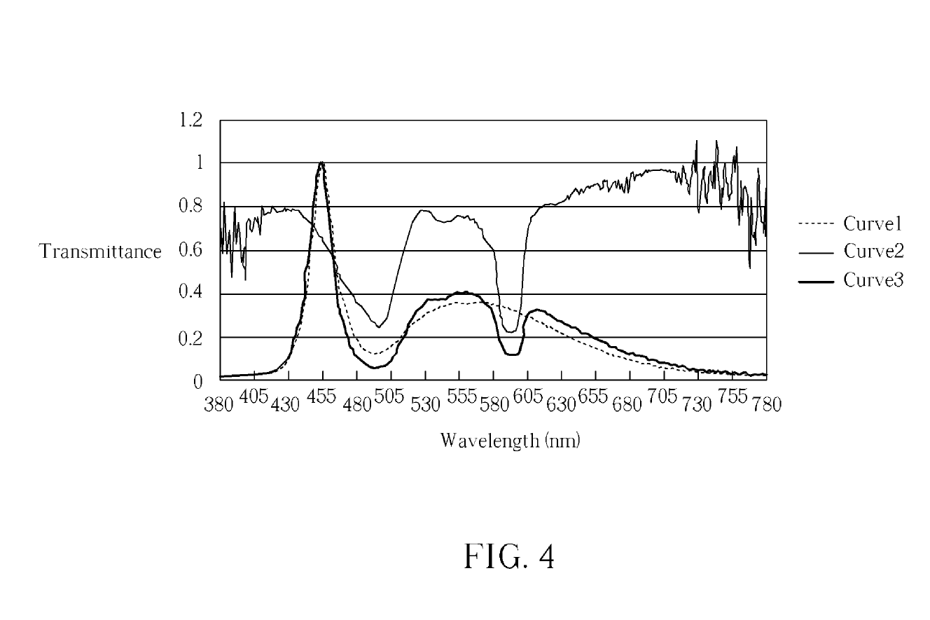

Please refer to FIG. 4. FIG. 4 is a transmittance vs. wavelength relationship chart. In this embodiment, a two-wave white LED device is used as light source. Curve 1 represents a transmittance vs. wavelength relation with respect to the white light beams of the light source, curve 2 represents a transmittance vs. wavelength relation with respect to the optical filter 20, and curve 3 represents a transmittance vs. wavelength relation with respect to the white light beams after passing through the optical filter 20. As curve 1 of FIG. 4 shows, the white light source generated by the back light unit 10 has two peaks in visible light wavelength range (between 380 nm and 780 nm). One peak is located within the blue light wavelength range, and the other is located between the green light wavelength range and the red light wavelength range. The transmittance of the white light source between the blue light wavelength range and the red light wavelength range is approximately 15%, and the boundary between green light and red light is vague. Consequently, there is no clear distinction between the red light, green light, and blue light, which deteriorates the gamut of the LCD panel 30.

As curve 2 of FIG. 4 shows, the optical filter 20 has a lower transmittance with respect to the light beams having a wavelength between the red light wavelength range and the green light wavelength range (approximately 565 nm and 615 nm), and with respect to the light beams having a wavelength between the green light wavelength range and the blue light wavelength range (approximately 473 nm and 523 nm). In this embodiment, for instance, the transmittance of the optical filter 20 with respect to the red-green light having a wavelength within 565 nm and 615 nm, and with respect to the green-blue light having a wavelength within 473 nm and 523 nm is about 20%. On the other hand, the transmittance of the optical filter 20 with respect to the light beams beyond the above wavelength range reaches 50% to 100%. Based on different display specification or requirement, the transmittance of the optical filter 20 can be modified to a value lower than a particular transmittance by, for instance, using different materials or adding different dyes. The particular transmittance may be, for example, between 10% and 40%, but not limited. Accordingly, most of the light beams having a wavelength between the red light wavelength range and the green light wavelength range, and most of the light beams having a wavelength between the green light wavelength range and the blue light wavelength range will be filtered out by the optical filter 20 before entering the light guide plate 16, so that the red, green, and blue light emitting from the back light unit 10 are distinctive. As curve 3 shows, the intensity of the light beams between the red light wavelength range and the green light wavelength range, and between the green light wavelength range and the blue light wavelength range are reduced, and consequently three obvious peaks can be observed within the red light wavelength range, the green light wavelength, and the blue light wavelength range.

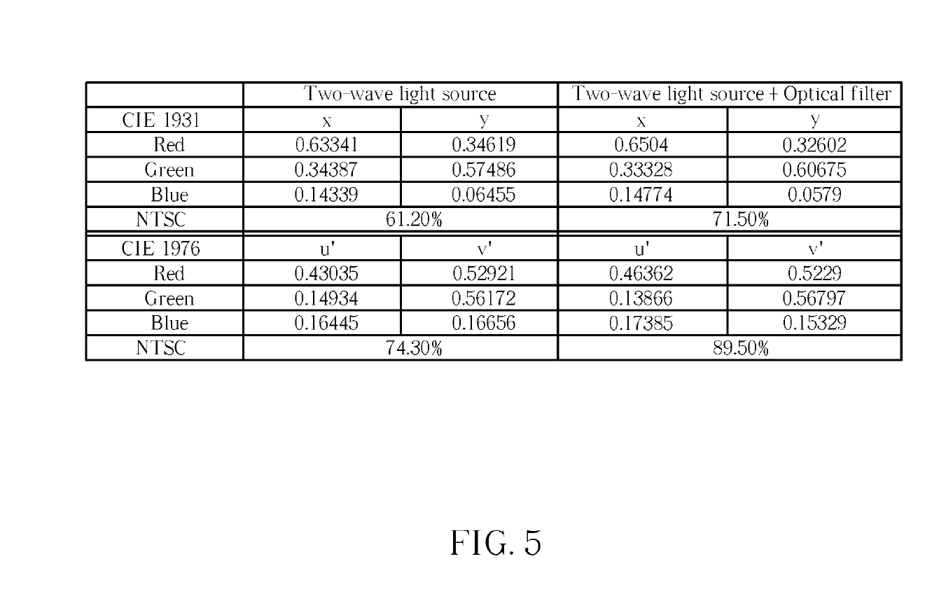

Please refer to FIG. 5. FIG. 5 illustrates color coordinates of the two-wave LED light source incorporated with an optical filter, wherein two color matching functions including CIE 1931 and CIE 1976 are shown in FIG. 5. According to CIE 1931 system, the light source without an optical filter 20 incorporated therein has a red light coordinate (x, y) of (0.63341, 0.34619), a green light coordinate of (0.34387, 0.57486), a blue light coordinate of (0.14339, 0.06455), and an NTSC percentage of 61.20%; the light source with an optical filter 20 has a red light coordinate of (0.6504, 0.32602), a green light coordinate of (0.33328, 0.60675), a blue light coordinate of (0.14774, 0.0579), and an NTSC percentage of 71.50%. According to CIE 1976 system, the light source without an optical filter 20 incorporated therein has a red light coordinate (u′, v′) of (0.43035, 0.52921), a green light coordinate of (0.14934, 0.56172), a blue light coordinate of (0.16445, 0.16656), and an NTSC percentage of 74.30%; the light source with an optical filter 20 has a red light coordinate of (0.46362, 0.5229), a green light coordinate of (0.13866, 0.56797), a blue light coordinate of (0.17385, 0.15329), and an NTSC percentage of 89.50%.

The optical filter of the present invention is confirmed to be able to absorb light beams within a particular wavelength range, so as to increase the gamut of the light source. In the aforementioned embodiments, LED device is used to be the light generator, and the back light unit is edge-light type back light unit. However, the present invention is not limited by these embodiments. Other embodiments will be described in the following paragraphs. It is appreciated that like components are denoted by like numerals in some embodiments for better comparison between different embodiments.

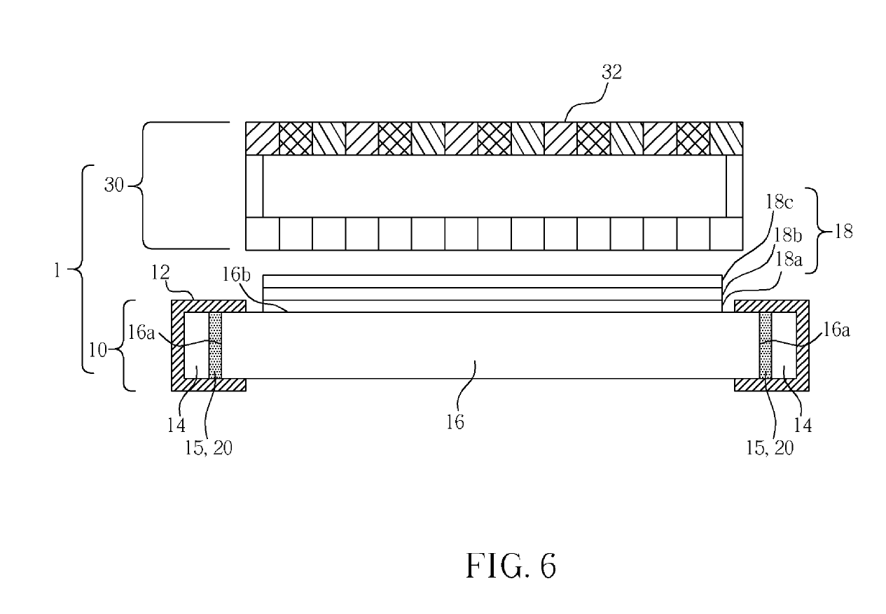

FIG. 6 schematically illustrates an LCD device according to another embodiment of the present invention. As shown in FIG. 6, the LCD device 1 includes an LCD panel 30, and a back light unit 10 (also edge-light type) disposed under the LCD panel 30. The back light unit 10 is an edge-light type back light unit, which provides light for the LCD panel 30 when displaying images. The back light unit 10 includes a housing 12, light generators 14, a light guide plate 16, and a diffusion device 18. The light generators 14 are disposed on two opposite sides of the housing 12 for generating white light beams. Note that the light generators 14 may also be located on one side of the housing 12 based on the brightness requirement. The light guide plate 16 is disposed inside the housing 12, and the light beams generated by the light generators 14 enter the light guide plate 16 from two sides, and are reflected to the LCD panel 30. The diffusion device 18 is disposed in between the back light unit 10 and the LCD panel 30. In addition, the LCD panel 30 includes color filters 32, which divide the white light beams into red, green, and blue light beams.

In this embodiment, the light generators 14 are also white LED device, but the optical filter 20 is directly incorporated into the encapsulated layer 15 of the LED device, instead of adhering to the incident plane 16a of the light guide plate 16.

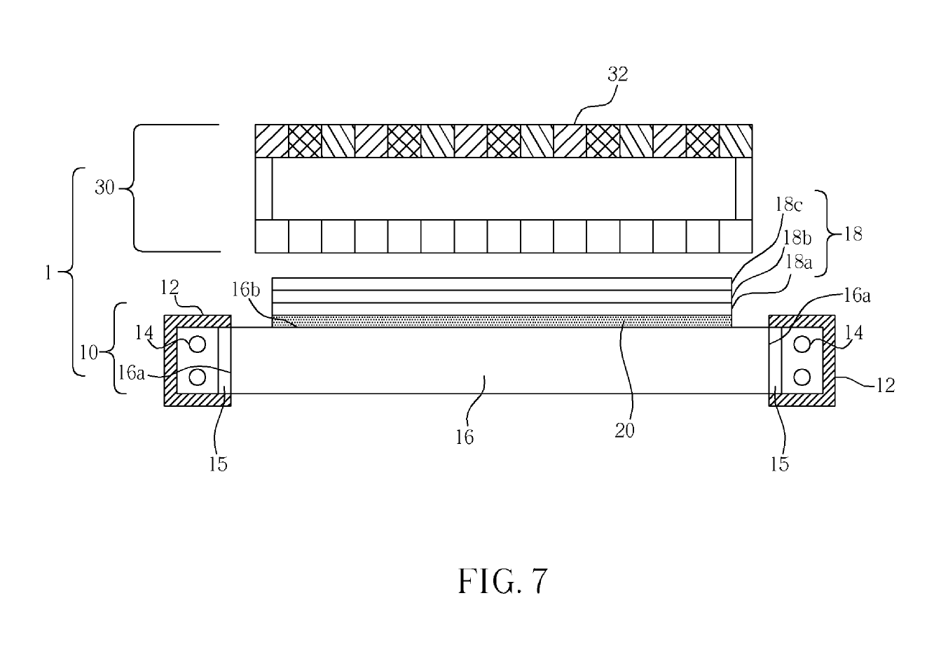

FIG. 7 is a schematic diagram illustrating an LCD device according to another embodiment of the present invention. As shown in FIG. 7, the LCD device 1 includes an LCD panel 30, and a back light unit 10 disposed under the LCD panel 30. The back light unit 10 is an edge-light type back light unit, which provides light for the LCD panel 30 when displaying images. In this embodiment, the optical filter 20 is disposed on the exiting plane 16b of the light guide plate. The optical filter 20 may be disposed inside the diffusion device 18, for instance, between the diffusion plate 18a and the prism 18b, between the prism 18b and the brightness enhanced film 18c, on the surface of the brightness enhanced film 18c facing the LCD panel, on the surface of the LCD panel 30 facing the diffusion device 18, or on the surface of any thin film of the diffusion device 18 based on different display requirements.

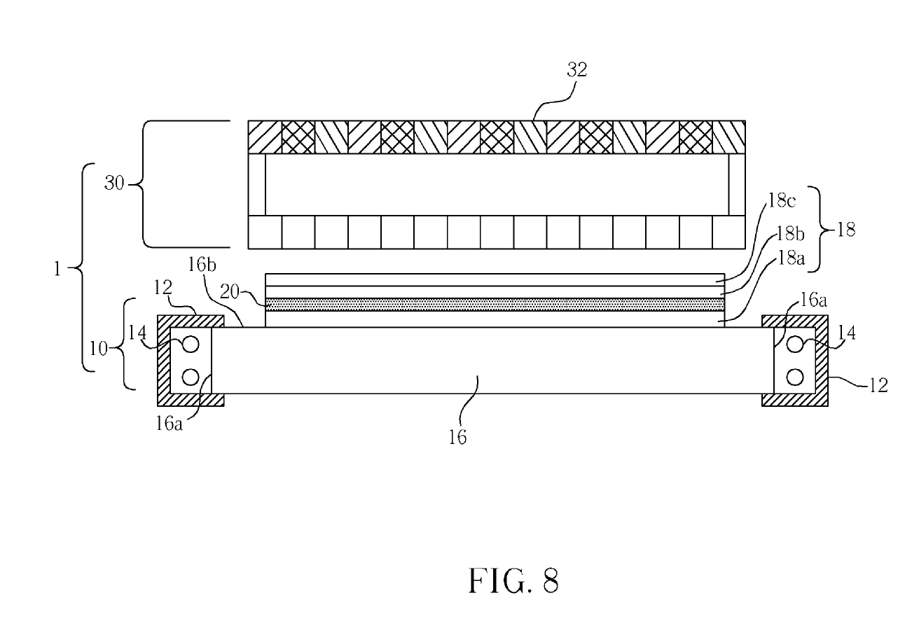

Please refer to FIG. 8. FIG. 8 is a schematic diagram illustrating an LCD device according to another embodiment of the present invention. As shown in FIG. 8, the LCD device 1 includes an LCD panel 30, and a back light unit 10 disposed under the LCD panel 30. The back light unit 10 is an edge-light type back light unit, which provides light for the LCD panel 30 when displaying images. In this embodiment, the light generators 14 are fluorescent lamps. The fluorescent lamps may be various types of fluorescent lamps e.g. cold cathode fluorescent lamps (CCFLs), hot cathode fluorescent lamps (HCFLs), external electrode fluorescent lamps (EEFLs), etc. In addition, the optical filter 20 is disposed between the diffusion plate 18a and the prism 18b of the diffusion device 18, but not limited.

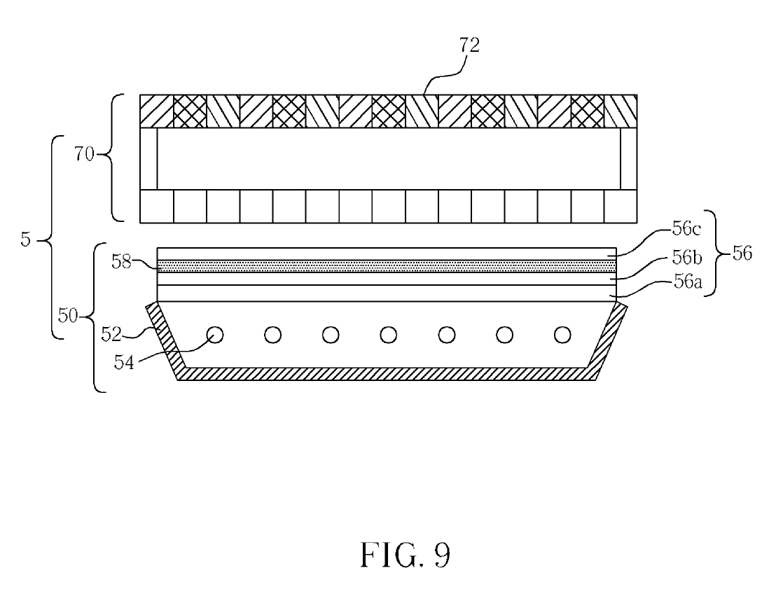

The back light unit of the present invention may also be direct-light type. Please refer to FIG. 9. FIG. 9 is a schematic diagram illustrating an LCD device according to another embodiment of the present invention. As shown in FIG. 9, the LCD device 5 includes an LCD panel 70 and a back light unit 50 disposed under the LCD panel 70. The back light unit 50 is a direct-light type back light unit, which provides light for the LCD panel 70. The back light unit 50 includes a housing 52, light generators 54, and a diffusion device 56. The light generators 54 are disposed inside the housing, and right below the LCD panel for generating light beams. The diffusion device 56, which may include diffusion plate 56a, prism 56b, and brightness enhanced film 56c, etc., is disposed between the back light unit 50 and the LCD panel 70. In this embodiment, the light generators 54 are cold cathode fluorescent lamps, but may also be other types of lamps. In addition, the LCD panel 70 includes color filters 72, which divide the white light beams into red, green, and blue light beams.

As shown in FIG. 9, the LCD device 5 further includes an optical filter 58 disposed between the light generators 54 and the diffusion device 56. In this embodiment, the optical filter 58 is disposed between the prism 56b and the brightness enhanced film 56c of the diffusion device 56, but may be modified wherever necessary.

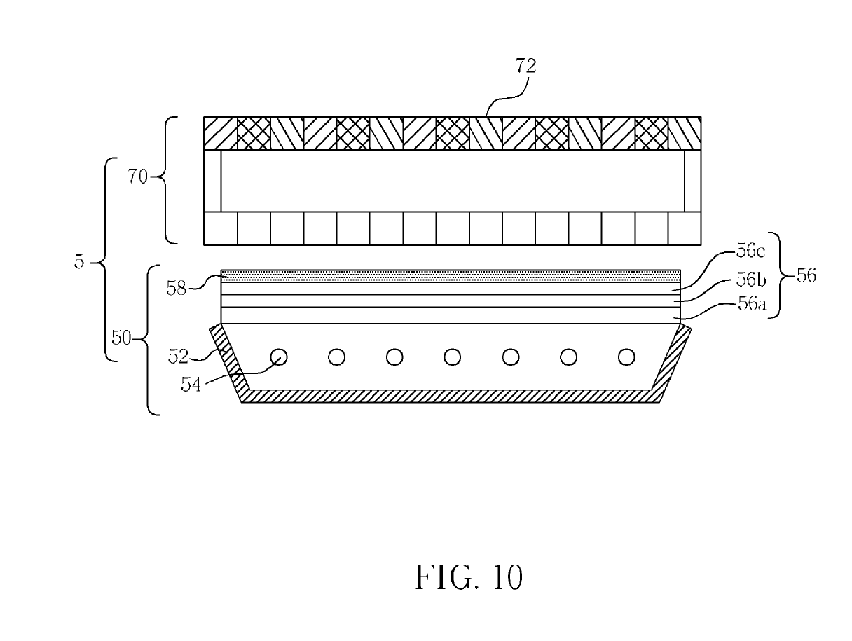

Please refer to FIG. 10. FIG. 10 is a schematic diagram illustrating an LCD device according to another embodiment of the present invention. As shown in FIG. 10, the LCD device 5 includes an LCD panel 70 and a back light unit 50 disposed under the LCD panel 70. The back light unit 50 is a direct-light type back light unit, which provides light for the LCD panel 70. In this embodiment, the optical filter 58 is disposed on the surface of the diffusion device 56 facing the LCD panel 70. However, the optical filter 58 may also be disposed in other locations such as on the surface of the diffusion plate 56a facing the light generators 54, between the diffusion plate 56a and the prism 56b, or on the surface of the LCD panel 70 facing the diffusion device 56.

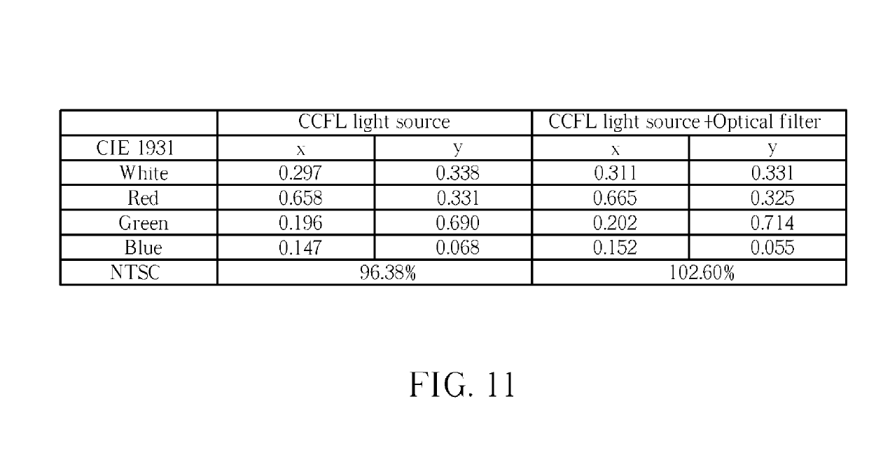

Please refer to FIG. 11. FIG. 11 illustrates color coordinates of the CCFL light source incorporated with an optical filter. As shown in FIG. 11, according to CIE 1931 system, the CCFL light source without an optical filter 58 incorporated therein has a white light coordinate (x, y) of (0.297, 0.338), a red light coordinate of (0.658, 0.331), a green light coordinate of (0.196, 0.690), a blue light coordinate of (0.147, 0.068), and an NTSC percentage of 96.38%; the CCFL light source with an optical filter 58 has a white light coordinate of (0.311, 0.331), a red light coordinate of (0.665, 0.325), a green light coordinate of (0.202, 0.714), a blue light coordinate of (0.152, 0.055), and an NTSC percentage of 102.60%.

The optical filter of the present invention is able to absorb the light beams within a particular wavelength as shown in FIG. 2 and FIG. 4. The material of the optical filter may be polymer material e.g. porphyrins, or other suitable materials. In addition, the structure of the optical filter is not limited to a single-layer structure made of a single material, and can be a multi-layered structure made of different materials.

In conclusion, the back light unit incorporates the optical filter to filter out the light beams within unnecessary wavelength range of visible light, so as to provide the light source with high gamut. The filtered light source can improve color performance after passing through the color filter of the LCD panel. The optical filter and the color filter can both filter light beams within particular wavelength ranges, but the functions are different. Form the view of optical path, the optical filter is disposed prior to the color filter. The function of the optical filter is to filter the white light source in advance, thereby overcome the inherent disadvantage of current white light source. The optical filter does not change the hue of the light beams passing through. In other word, the hue of the white light beams before and after passing through the optical filter are the same. In contrast, the white light beams will be filtered by the color filter subsequently. The white light beams will be then divided into light beams with different primary colors e.g. red, green, and blue.

The back light unit of the present invention can be various types e.g. direct-light type, or edge-light type, and the light generator is not limited to fluorescent lamp or LED device. The optical filter may be disposed at any position of the optical path between the light generator and the LCD panel. In addition, the material of the optical filter can be organic or inorganic, and the structure of the optical filter can be single-layered or multi-layered. Furthermore, the transmittance of the light beams having a wavelength within particular range of visible light can be modified by adding dyes or doping impurities to obtain better color management.

Those skilled in the art will readily observe that numerous modifications and alterations of the device and method may be made while retaining the teachings of the invention.

What is claimed is:

1. A back light unit adapted to provide light to a liquid crystal display panel, the back light unit comprising:
a housing;
at least a light generator disposed inside the housing for generating white light beams; and
an optical filter disposed in an optical path of the white light beams between the light generator and the liquid crystal display panel for filtering the white light beams within a particular wavelength range of visible light, wherein the hue of the white light beams before and after passing through the optical filter are the same.

2. The back light unit of claim 1, wherein the particular wavelength range is between blue light wavelength range and green light wavelength range.

3. The back light unit of claim 2, wherein the particular wavelength range is substantially between 473 nm and 523 nm.

4. The back light unit of claim 1, wherein the particular wavelength range is between green light wavelength range and red light wavelength range.

5. The back light unit of claim 4, wherein the particular wavelength range is substantially between 565 nm and 615 nm.

6. The back light unit of claim 1, wherein the back light unit comprises a light guide plate disposed inside the housing, the at least one light generator is disposed on at least one side of the light guide plate, and the light guide plate has an incident plane where the white light beams enter and an exiting plane where the white light beams exit.

7. The back light unit of claim 6, wherein the optical filter is disposed on the incident plane of the light guide plate.

8. The back light unit of claim 6, wherein the optical filter is disposed on the exiting plane of the light guide plate.

9. The back light unit of claim 1, wherein the at least one light generator disposed right below the liquid crystal display panel.

10. The back light unit of claim 1, wherein the light generator comprises a fluorescent lamp.

11. The back light unit of claim 1, wherein the light generator comprises a light emitting diode device.

12. The back light unit of claim 11, wherein the light emitting diode device comprises an encapsulated layer, and the optical filter is integrated into the encapsulated layer of the light emitting diode device.

13. A liquid crystal display device, comprising:
a liquid crystal display panel comprising a color filter; and
a back light unit disposed below the liquid crystal display panel for providing light to the liquid crystal display panel, the back light unit comprising:
a housing;
at least a light generator disposed inside the housing for generating white light beams; and
an optical filter disposed in an optical path of the white light beams between the light generator and the liquid crystal display panel, the optical filter having a particular transmittance with respect to light beams within a particular wavelength range of visible light.

14. The liquid crystal display device of claim 13, wherein the particular transmittance is between 10% and 40%.

15. The liquid crystal display device of claim 13, wherein the particular wavelength range is between blue light wavelength range and green light wavelength range.

16. The liquid crystal display device of claim 15, wherein the particular wavelength range is substantially between 473 nm and 523 nm

17. The liquid crystal display device of claim 13, wherein the particular wavelength range is between green light wavelength range and red light wavelength range.

18. The liquid crystal display device of claim 17, wherein the particular wavelength range is substantially between 565 nm and 615 nm.

19. The liquid crystal display device of claim 13, wherein the back light unit comprises a light guide plate disposed inside the housing, the at least one light generator is disposed on at least one side of the light guide plate, and the light guide plate has an incident plane where the white light beams enter and an exiting plane where the white light beams exit.

20. The liquid crystal display device of claim 19, wherein the optical filter is disposed on the incident plane of the light guide plate.

21. The liquid crystal display device of claim 19, wherein the optical filter is disposed on the exiting plane of the light guide plate.

22. The liquid crystal display device of claim 13, wherein the at least one light generator disposed right below the liquid crystal display panel.

23. The liquid crystal display device of claim 13, further comprising a diffusion device in between the back light unit and the liquid crystal display panel.

24. The liquid crystal display device of claim 23, wherein the optical filter is disposed inside the diffusion device.

25. The liquid crystal display device of claim 23, wherein the optical device is disposed in between the diffusion device and the liquid crystal display panel.

26. The liquid crystal display device of claim 13, wherein the light generator comprises a fluorescent lamp.

27. The liquid crystal display device of claim 13, wherein the light generator comprises a light emitting diode device.

28. The liquid crystal display device of claim 27, wherein the light emitting diode device comprises an encapsulated layer, and the optical filter is integrated into the encapsulated layer of the light emitting diode device.

29. The liquid crystal display device of claim 13, wherein the white light beams generated by the light generator go through the optical filter before going through the color filter.

30. The liquid crystal display device of claim 29, wherein the white light beams remain white after going through the optical filter, and the white light beams are divided into light beams with different primary colors after going through the color filter.
